(19) United States
(12) Patent Application Publication
(10) Pub. No.: US 2019/0362374 A1
(43) Pub. Date: Nov. 28, 2019

(54) MARKDOWN OPTIMIZATION SYSTEM

(71) Applicant: Walmart Apollo, LLC, Bentonville, AR (US)

(72) Inventors: Abhishek MUNGOLI, Haldwani (IN); Avinash M. JADE, Bangalore (IN); Madhur SARIN, Gurgaon (IN); Aloka SUDHODANAN, Palakkad (IN); Biswajit PAL, Bangalore (IN); Hari Narayanan PARAMESWARAN, Kochi (IN); Esha SWAROOP, New Delhi (IN); Meduri S N V Sai YASWANTH, Kakinada (IN); Rohit KUMAR, Bangalore (IN)

(21) Appl. No.: 16/029,622

(22) Filed: Jul. 8, 2018

(30) Foreign Application Priority Data
May 26, 2018 (IN) 201841019747

(51) Int. Cl. G06Q 30/02

(52) U.S. Cl. CPC G06Q 30/0223; G06Q 30/0202

(57) ABSTRACT

The system and method described herein provide a computationally efficient clearance markdown planning system that may quickly automate the calculations of many possible markdown plans to determine the impact of various pricing options on total sales volume and revenue. While considering business constraints and other parameters, the markdown planning system may determine an optimized markdown plan for a particular product, season, and locale. In some aspects, the markdown planning system may use scaling and a variation of dynamic programming (DP) to quickly calculate and compare different potential markdown plans.

### BACKGROUND

A merchant may procure and sell products with a goal to maximize revenue or minimize waste. Often a retailer may manage sales volume by manipulating pricing for various products. Many factors may impact the price for a product, including seasonality, demand, and availability of substitute or complementary products. Likewise, the price of a product may impact the sales volume and revenue that may be generated. When a product has a limited shelf-life (such as due to the perishability of the product or the demand for the product over time), a retailer may be faced with an inventory surplus. A discount in price may renew demand, while generating lower revenue.

### SUMMARY

This Summary is provided to introduce a selection of concepts (in a simplified form) that is further described below in the Detailed Description. This Summary is not intended to identify key features or essential features of the claimed subject matter, nor is it intended to be used as an aid in determining the scope of the claimed subject matter.

One aspect of the subject matter described in this disclosure may be implemented as a markdown planning system. The markdown planning system may include an input/output system, a revenue optimization module, a sales volume forecasting module, and a markdown plan generation module. The input/output system may be configured to receive inputs related to the at least one product, the inputs including a starting inventory, a starting per-unit price, and a maximum markdown period. The revenue optimization module may be configured to determine an amount of an available computing resource in the markdown planning system, determine a scaling factor based on the starting inventory value and the amount of the available computing resource in the markdown planning system, scale the starting inventory to a scaled inventory value based, at least in part, on the scaling factor, and determine one or more potential markdown plans for the at least one product based, at least in part, on the inputs and a set of markdown plan constraints. Each potential markdown plan may include one or more markdown steps, and each markdown step may include a different combination of markdown pricing and markdown duration. The sales volume forecasting module may be configured to determine an estimated sales volume for each markdown step in a potential markdown plan based, at least in part, on an amount of the scaled inventory value remaining after a previous markdown step in the potential markdown plan. The sales volume forecasting module may utilize dynamic programming (DP) to store and provide previous calculations for different combinations of scaled inventory value, markdown pricing, and markdown duration. The markdown plan generation module may be configured to determine a total estimated revenue associated with each of the one or more potential markdown plans, and determine an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints.

In some implementations, the sales volume forecasting module may be configured to receive a combination of scaled inventory value, markdown pricing, and markdown duration for a markdown step from the revenue optimization module and determine whether the estimated sales volume for the combination is stored in a memory. If the estimated sales volume is not stored in the memory, the sales volume forecasting module may calculate the estimated sales volume for the combination, provide the estimated sales volume for the markdown step to the revenue optimization module, and store the estimated sales volume for the combination in the memory. If the estimated sales volume is stored in the memory, the sales volume forecasting module may retrieve the estimated sales volume from the memory and provide the estimated sales volume for the markdown step to the revenue optimization module.

In some implementations, the sales volume forecasting module may be configured to determine the estimated sales volume based, at least in part, on historical sales data, a baseline volume for the product, a sales price, and price elasticity.

In some implementations, the sales volume forecasting module may be configured to determine the estimated sales volume based, at least in part, on an effect of seasonality associated with the at least one product.

In some implementations, the available computing resource is a memory, and the amount of the available computing resource is limited based, at least in part, on a system architecture of the markdown planning system.

In some implementations, the set of the markdown plan constraints include at least one constraint selected from a group consisting of a maximum quantity of markdown steps, minimum duration between markdown steps, a maximum waste amount, a sell-through target, and minimum markdown percentage for each step.

In some implementations, the revenue optimization module may be configured to discard a potential markdown plan that does not satisfy the set of the markdown plan constraints.

In some implementations, the markdown plan generation module may be further configured to verify that the optimized markdown plan satisfies the set of markdown plan constraints.

In some implementations, the set of markdown plan constraints are user-configurable parameters or system-configurable parameters.

In some implementations, the input/output system may include a user interface. The markdown plan generation module may be configured to provide the optimized markdown plan via the user interface.

In some implementations, the input/output system may be configured to receive different inputs for each of a plurality of products. The markdown planning system may use parallel processing to determine a corresponding optimized markdown plan for each of the plurality of products.

In some implementations, the markdown planning system may include a plurality of processing computers. Each processing computer may include a corresponding revenue optimization module, sales volume forecasting module, and markdown plan generation module. The plurality of processing computers may form a computer cluster for concurrently determining optimized markdown plans for each of a plurality of products.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

The present description will be better understood from the following detailed description read in light of the accompanying drawings.

FIG. 1 depicts an example system diagram to introduce concepts of the computationally efficient clearance markdown planning system.

FIG. 2 depicts example markdown plans.

FIG. 3 depicts example input parameters, example markdown plan constraints, and example optimized markdown plan outputs associated with a markdown planning system.

FIG. 4 depicts a conceptual process for dynamic programming (DP) which may be used in a markdown planning system.

FIG. 5 depicts example calculations that may be performed by a markdown planning system.

FIG. 6 depicts example variations for a markdown planning system.

FIG. 7 depicts an example system diagram showing example components of a markdown planning system.

FIG. 8 depicts an example flowchart for determining an optimized markdown plan.

FIG. 9 depicts an example functional block diagram of an operating environment in which some aspects of this disclosure may be implemented.

Corresponding reference characters indicate corresponding parts throughout the drawings. The systems depicted in the figures are illustrated as schematic drawings. Note that the relative dimensions of the figures may not be drawn to scale.

### DETAILED DESCRIPTION

The systems and methods described herein are related to a markdown planning system. A markdown plan is a schedule of price reductions taken over a markdown period with the purpose of clearing inventory. Markdowns occur for various reasons including planned assortment transitions or resets, product obsolescence and discontinuance brought on by changes in technology, taste, law and a myriad of other factors that affect consumer demand. For example, a retailer may offer various seasonal products which start to sell at the beginning of a season and are taken off the self as the season ends. Typically, a store manager may attempt to liquidate these products before the end of the season to avoid waste and loss of revenue. Examples of seasonal products may include seasonal clothes (winter clothing, summer bathing suits, etc.), barbeque items, seasonal foods, or the like. These products may go out of fashion or expire as the season ends. An optimal pricing strategy may ensure sell-out within the shelf-life of the product while maximizing revenue. Currently, a store manager may manually specify levels of discounts to be given and the dates at which the discounts should be effective during the season. This existing process is non-scientific and largely driven by business instincts. Demand for a product may be a function of various factors, such as seasonality (natural demand fluctuation due to utility of the product during a particular season of the year), price of the product, price of its substitutes and complements, events (such as local events like fairs as well as national events like holidays), or price offered by competitors for the same product. A retailer may stock an inventory of the product to match a sales forecast based on projected demand. However, if the demand is lower than the forecast, the retailer may end up with a surplus inventory before the end of the season for that product. Demand also may be a function of the price of the product. Price of the product is a variable which a retailer may set within some constraints.

Several pricing optimization techniques are available today to assist in determining a price that will generate the desired sales volume. Traditional pricing optimization techniques may be limited in scope to reduce complexity. Thus, traditional pricing optimization techniques may not adequately support a diverse set of options, business constraints, sales volume targets, or scheduling considerations. A markdown plan may include multiple pricing levels for a product, where the price changes in steps over a markdown period of time. Furthermore, when considering cross-related products, seasonality, quantity of price changes, starting inventory, target ending inventory, or other factors, traditional pricing optimization techniques may be slow or inefficient due the many combinations or permutations that may be possible. Computer technology may be improved to better support markdown planning.

This disclosure provides improvements to computer technology related to markdown planning. A computationally efficient clearance markdown planning system may quickly automate the calculations of many possible markdown plans to determine the impact of various pricing options on total sales volume and revenue. While considering business constraints and other parameters, the markdown planning system may determine an optimized markdown plan for a particular product, season, and locale. In some aspects, the markdown planning system may use scaling and a variation of dynamic programming (DP) to quickly calculate and compare different potential markdown plans. Thus, the disclosed markdown planning system may generate an optimized clearance markdown plan for vast inventories of products, various retail locations, or the like. The computational efficiency of the disclosed markdown planning system may decrease consumption of available computer resources, improve speed, and provide a useful planning tool for retailers.

In accordance with this disclosure, an optimized markdown plan may set a schedule of price reductions to stimulate demand and purchasing of the product before the end of the season. A markdown planning system may automate the process of generating a markdown plan using sales forecasting and revenue optimization techniques. The markdown plan may be optimized using analytical models to maximize revenue and reduce waste. A user of the markdown planning system may consider or compare different scenarios by modifying initial parameters like initial stock, clearance date and minimum sell-through target.

The markdown planning system may provide a customized pricing strategy for multiple products at a retail location (or multiple retail locations). The markdown planning system may utilize improvements to computer technology to enhance the speed, usability, and utility of the markdown planning system. For example, a variant of dynamic programming (DP) may be used to reduce the amount of calculations that the markdown planning system would otherwise perform. The markdown planning system may scale to support very large inventories or multiple products or stores. In one aspect, the markdown planning system may modify computational efficiency based on available computer resource (such as memory, processor speed, or the like). A scaling factor for adjusting the inventory during calculations may be based on an amount of the available computer resource. In some implementations, the scaling factor may be dynamically adjusted, manually configured, or a combination of manual configuration followed by dynamic adjustment.

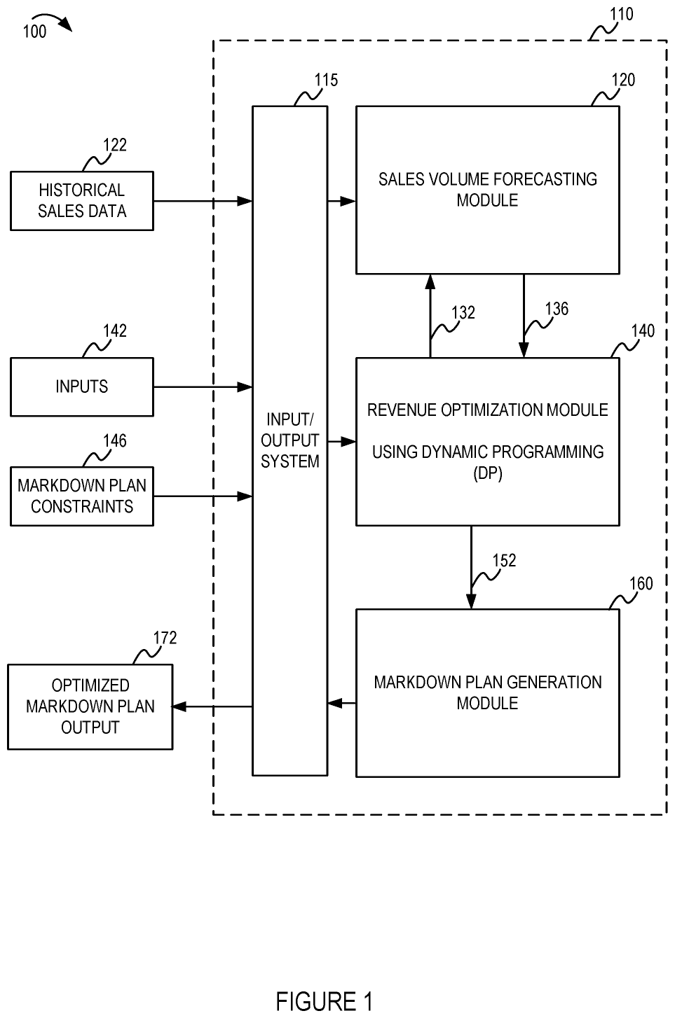

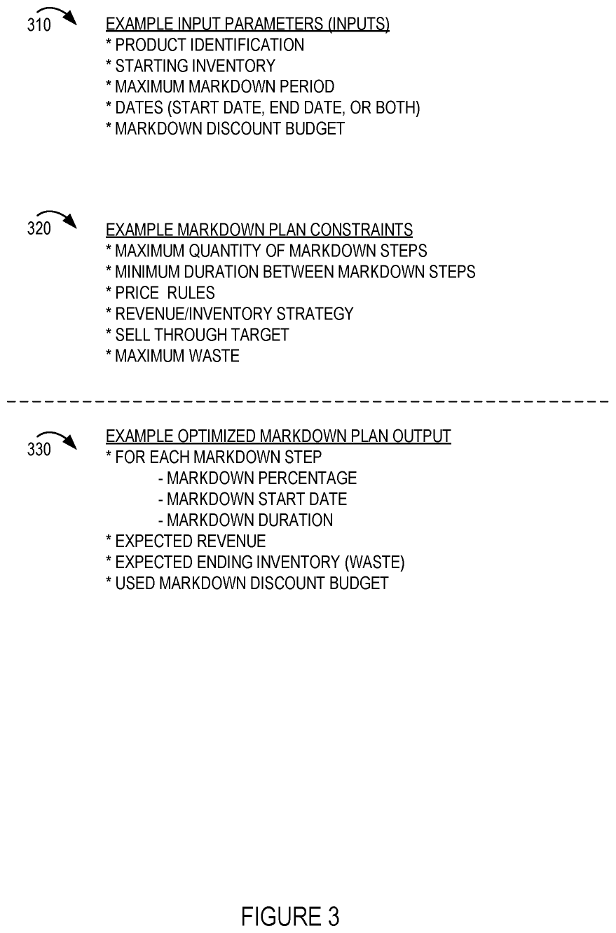

FIG. 1 depicts an example system diagram to introduce concepts of the computationally efficient clearance markdown planning system. The system 100 shows a markdown planning system 110. The markdown planning system 110 includes an input/output system 115, a revenue optimization module 140, a sales volume forecasting module 120, and a markdown plan generation module 160. The input/output system 115 provides an interface for external input or output. For example, the input/output system 115 may include a user interface or a communication interface. The markdown planning system 110 (via the input/output system 115) may receive inputs 142 associated with one or more products. For example, the inputs may include a starting inventory, a starting per-unit price, and a maximum markdown period. Furthermore, a set of markdown plan constraints 146 (which also may be referred to as business constraints) may be programmed into or received by the markdown planning system 110. The revenue optimization module 140 may use the inputs 142 and the markdown plan constraints 146 to determine one or more potential markdown plans. Examples of the inputs 142 and the markdown plan constraints 146 are further described in FIG. 3. As a brief example, the markdown plan constraints 146 may include a rule that waste must be below 10% (which also may be referred to as a sell-through target of 90%). Thus, even if there may be a potential markdown plan that results in higher revenue but with 15% waste, the revenue optimization module 140 may discard that potential markdown plan because it doesn't satisfy the example markdown plan constraint.

Each potential markdown plan determined by the revenue optimization module 140 may include one or more markdown steps. A markdown step represents a markdown price (such as a percentage discount) and a markdown duration (such as a number of weeks for that markdown price). Thus, each markdown step may include a different combination of markdown pricing and markdown duration. The revenue optimization module 140 may process the potential markdown plans to determine estimated revenue. To determine the estimated revenue, the revenue optimization module 140 may obtain estimated sales volume from the sales volume forecasting module 120. For example, the revenue optimization module 140 may send a combination of markdown pricing, markdown duration, and inventory (markdown step combination 132) to the sales volume forecasting module 120. The sales volume forecasting module 120 may determine an estimated sales volume 136 based on the markdown step combination 132.

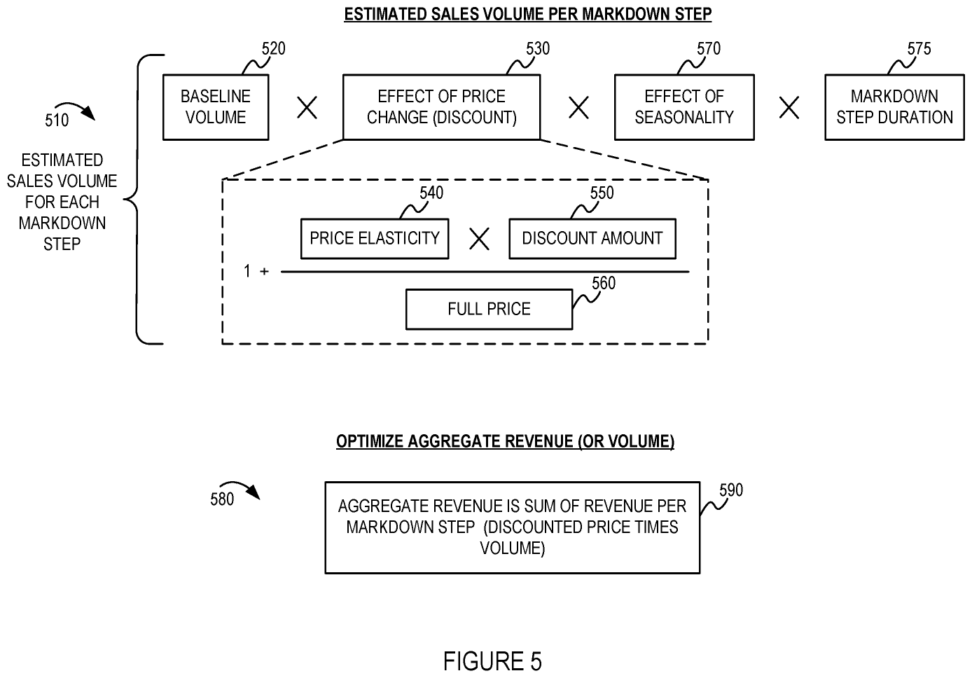

The sales volume forecasting module 120 may utilize historical sales data 122 (which also may be referred to as training data or baseline data) to determine the estimated sales volume 136. There may be different algorithms or formulas used by the sales volume forecasting module 120 to determine the estimated sales volume 136. Example algorithms and formulas are described further in FIG. 5. In some implementations, the sales volume forecasting module 120 may determine a baseline volume for the product. The effect of a markdown price (discounted sales price) may be calculated. In some implementations, price elasticity, seasonality, or other factors (such as location, events, weather predictions, etc.) may be used to determine the estimated sales volume 136 for the markdown step combination 132. For each markdown step, the revenue optimization module 140 may use the estimated sales volume 136 to determine a lower inventory for the product before submitting the next markdown step combination 132 to the sales volume forecasting module 120. Thus, the changing inventory level at each markdown step may be factored into the estimated sales volume 136.

The revenue optimization module 140 (or the sales volume forecasting module 120) may use a variation of dynamic programming to increase the efficiency of determining an estimated sales volume for each markdown step. DP (which also may be referred to as dynamic optimization, or “memorization”) is a concept in computer science that is used to solve complex problems by breaking down a complex problem into a collection of simpler subproblems, solving each of those subproblems once, and storing the result of each subproblem so that the stored result may be used (rather than recalculating) if the same subproblem occurs. In the context of this disclosure, the revenue optimization module 140 (or the sales volume forecasting module 120) may store the estimated sales volume for each markdown step combination. Because the revenue optimization module 140 may process multiple markdown plans, there is a likelihood that different markdown plans may generate similar markdown step combinations. Using DP, the revenue optimization module 140 may prevent recalculation of an estimated sales volume if the result of a previous calculation may be used instead. Although FIG. 1 shows the DP implemented in the revenue optimization module 140, the DP may be implemented in the sales volume forecasting module 120. For example, the sales volume forecasting module 120 may receive a markdown step combination and determine if the sales volume forecasting module 120 has stored a previous calculation for a similar markdown step combination in another markdown plan. Using DP, the revenue optimization module 140 (or the sales volume forecasting module 120) may efficiently determine an estimated sales volume for each markdown step in many different potential markdown plans. After each markdown step, the revenue optimization module 140 may determine an amount of the inventory remaining after the markdown step and determine whether to send another markdown step to the sales volume forecasting module 120.

The revenue optimization module 140 may determine a total estimated revenue associated with each of the one or more potential markdown plans. For example, the revenue optimization module 140 may determine a markdown step revenue by multiplying the estimated sales volume for each markdown step with the markdown price using during the markdown step. The total estimated revenue is the sum of the markdown step revenue for all the markdown steps in the markdown plan.

The markdown plan generation module 160 may determine an optimized markdown plan from the potential markdown plans. For example, the markdown plan generation module 160 may select the potential markdown plan that has the highest revenue while still satisfying the set of markdown plan constraints. The markdown plan generation module 160 may prepare an optimized markdown plan output 172 which may be displayed on a user interface of the input/output system 115 or sent in a network communication via the input/output system 115.

In some implementations, the markdown planning system 110 may utilize a scaling factor to further improve the computational efficiency. For example, if a product has a very large inventory of products, the computational resources to calculate estimated sales volume and multiple markdown steps may be inefficient. A scaling factor may be used to reduce the inventory to a manageable number while the markdown plans are being calculated and compared. For example, the revenue optimization module 140 may determine an amount of an available computing resource (such as memory) in the markdown planning system 110. The revenue optimization module 140 may determine a scaling factor based on the starting inventory and the amount of the available computing resource. The starting inventory may be scaled to a scaled inventory value by dividing (or any mathematical transformation that may be reversed later) the starting inventory by the scaling factor. For example, if the starting inventory is 8000 units, but the memory of the markdown planning system 110 only supports enough computer resource to calculate a markdown plan for 4000 units, the revenue optimization module 140 may use a scaling factor of 2 to reduce 8000 to 4000. The example scaling factors in this disclosure are provided for illustrative purposes only. Other scaling factors, based on available computing resources, may be used in other examples provided by this disclosure. After the calculations (for estimated sales volume or revenue) have been performed, the markdown planning system 110 may multiple the calculations by the scaling factor. This process of scaling and descaling may be used to transform large number to smaller numbers for the markdown plan calculations.

In some implementations, the scaling factor may be predetermined by a user or system administrator based on available hardware. Alternatively, the scaling factor may be determined based on amount memory and the amount of memory used to manage different size arrays. In some implementations, a combination of manual configuration and dynamic modification may be used. For example, a user or system administrator may set a scaling factor (x) as an initial scaling factor setting. The initial scaling factor setting may be based on experience or experimental testing. The markdown planning system may adjust the initial scaling factor. For example, as the markdown planning system performs calculations, the markdown planning system may monitor memory utilization and adjust the scaling factor when preparing a markdown plan for another product or for a further markdown planning session. In some implementations, the markdown planning system may dynamically adjust the scaling factor based on the initial scaling factor setting and the amount of inventory (I) for a product. For example, the scaling factor (s) used for a particular produce may be calculated by dividing the inventory by the initial scaling factor. (s=I/x). In other implementations, the scaling factor may be determined by dividing the inventory by a machine variable (such a free memory, CPU processor speed, or the like). Other adjustment variables or factors may be used to determine the scaling factor based on available computing resources.

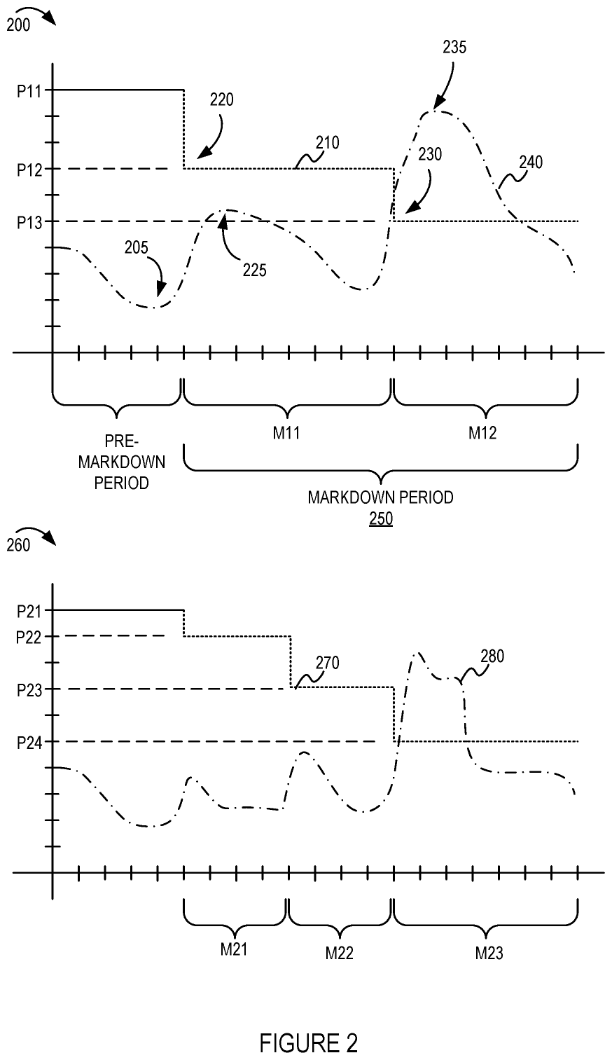

FIG. 2 depicts example markdown plans. A first time graph 200 shows a markdown plan 210 that includes two markdown steps. During a pre-markdown period, the product may be offered for sale at a starting price P11. For example, this may be referred to as “full price” (or undiscounted price). As part of planning for an end of the season (or discontinuation, liquidation, or clearance), a markdown plan 210 may begin with a first price reduction 220 (to a first markdown price P12) that begins a first markdown duration M11. A second price reduction 230 (to a second markdown price P13) may begin a second markdown duration M12 until the end of the markdown period. The markdown period 250 may include the first markdown duration M11 and the second markdown duration M12. Although the markdown plan 210 shows the markdown period 250 begins immediately with a price reduction, an optimized markdown reduction plan may include an initial duration where the product is offered for an undiscounted price. An estimated sales volume forecast 240 is superimposed on the first-time graph 200 to show the relationship between estimated sales volume and the pricing levels. For example, as sales volume dips at 205, the first price reduction 220 may stimulate an increase in sales volume (shown at 225). Likewise, the second price reduction 230 may stimulate an increase in sales volume (shown at 235). Ideally, the inventory of the product would be sold out by the end of the markdown period 250. However, in some implementations, the markdown plan constraints may permit a predetermined amount of wastage.

A second time graph 260 shows another markdown plan 270 that includes three markdown steps (with markdown prices P22, P23, P24 associated with markdown durations M21, M22, M23, respectively). The estimated sales volume forecast 280 shows the impact of the price reductions on the estimated sales volume.

The markdown planning system may compare these two potential markdown plans (and many more) to determine which potential markdown plan provides the highest revenue while satisfying the markdown plan constraints. For example, the markdown planning system may calculate a total revenue for each potential markdown plan and compare the total revenues. The markdown plan constraints also may be taking into consideration. For example, if the markdown plan constraints indicate that only two markdown durations may be used, the markdown planning system may discard the markdown plan 270 because it includes three markdown durations—even if the markdown plan 270 may provide a higher revenue. The markdown plan constraints also may impact the size of the price reductions for each markdown step (such as imposing a minimum or maximum size for price reductions in the markdown plan).

FIG. 3 depicts example input parameters 310, example markdown plan constraints 320, and example optimized markdown plan output 330 associated with a markdown planning system. In some implementation, a user interface may receive the input parameters 310 from a user of the markdown planning system. For example, a store manager or markdown manager may enter the input parameters in the markdown planning system to model different potential markdown scenarios. The input parameters 310 may include a product identification, a starting inventory, and a maximum markdown period. In some implementations, the markdown period (and the markdown durations in each markdown plan) may use a common measurement of time (such as weeks or days). In some implementations, the input parameters 310 also may include dates (such as a start date, end date, or both) associated with the markdown period. This information may be useful, for example, when preparing a markdown plan in advance of a season. The dates may be used by the sales volume forecasting module when determining estimated sales volume. In some implementations, the input parameters 310 may include a markdown discount budget. A markdown discount budget may refer to a budgeted amount of loss that the store manager or markdown manager would permit for the current markdown plan.

The markdown plan constraints 320 may be programmatically configured, system-configured, or user-configured parameters. Examples of the markdown plan constraints 320 may include a maximum quantity of markdown steps (such as 2 or 3 markdown steps), a minimum markdown duration between markdown steps, or a sell-through target (such as 90% sell-through). The markdown plan constraints 320 may include price rules. Price rules may define a price reduction amount that may be used in each step (such as >=5% steps for each considered price reduction step). The price rules may define a first markdown step should be >=10% price reduction. The price rules may indicate that the markdown price cannot drop below a salvage value associated with the product. The markdown plan constraints 320 also may be used to refine the strategy or goal of the markdown plan for a particular product. For example, instead of maximizing revenue, the goal may be more focused on clearing all inventory.

The optimized markdown plan output 330 may be presented to the user of the markdown planning system. Due to the computational efficiency of the markdown planning system, a user may manipulate the inventory 410 to see how they would modify the optimized markdown plan output 330. The optimized markdown plan output 330 may indicate the markdown plan in terms of markdown steps (markdown percentage, markdown start date, and markdown duration). In some implementations, the optimized markdown plan output 330 may be presented in a graphical format. The optimized markdown plan output 330 may indicate the total expected revenue, the expected ending inventory (waste), or the like. In some implementations, the optimized markdown plan output 330 may indicate how much of the markdown discount budget would be used if the optimized markdown plan is followed.

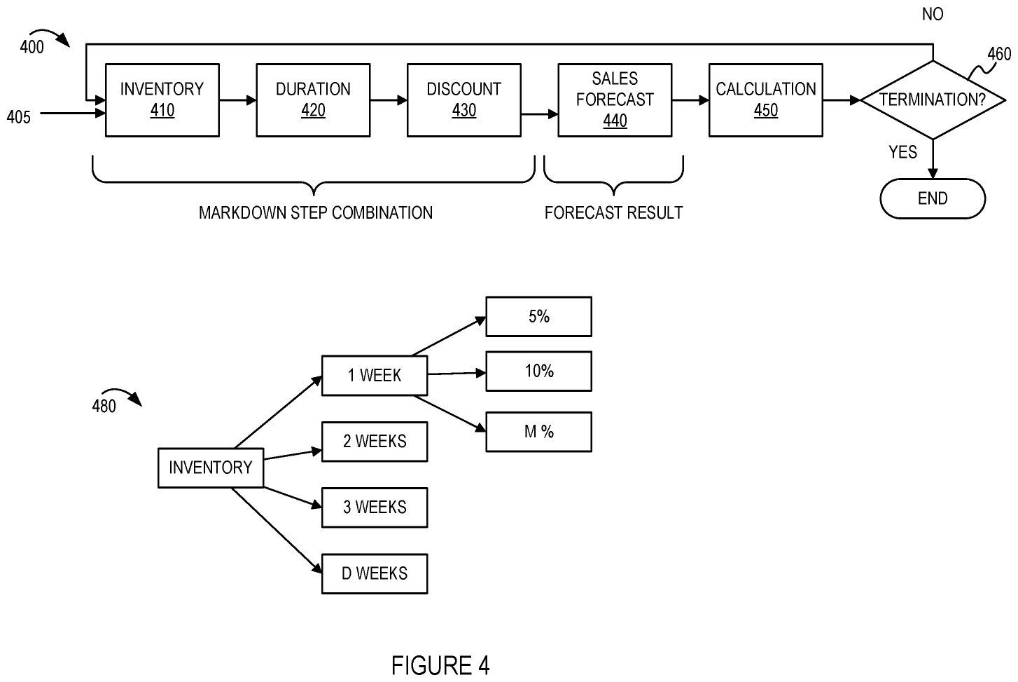

FIG. 4 depicts a conceptual process for DP which may be used in a markdown planning system. The markdown planning system may determine different potential markdown plans based on the inputs and markdown plan constraints. Shown at 480, an example graph shows some of the potential combinations. Starting with the inventory, the potential markdown plan may start with a first markdown step that lasts 1 week (markdown duration). During that week, the markdown price may be a price decrease of 5%, 10%, M %, etc. Although the chart only depicts the plan for the 1 week scenario, other markdown plans may start with a 2 week (markdown duration) in the first markdown step. The same price decreases (5%, 10%, M %, etc.) may be calculated for the 2 week scenario, and so forth. The amount of combinations for periods may be exponential based on how relaxed the markdown plan constraints. However, even though there may be many permutations of markdown plans that may be generated, the use of DP as described in this disclosure may reduce the complexity or processing requirements.

Before describing how DP may be used, it is helpful to describe how each potential markdown plan may be calculated (shown at block diagram 400). The potential first markdown step combination may be calculated beginning with a starting inventory 405. The markdown step combination may include the inventory 410, duration, 420, and discount 430. By way of example, the starting inventory may be 5000 units. For a first potential markdown plan, the first markdown step may be a 2 week duration with a 15% price reduction. Together, this combination of parameters may be sent to the sales volume forecasting module to determine an estimated sales volume. The estimated sales volume (which also may be referred to as a sales forecast 440) may indicate that 2000 units would be sold. At block 450, the revenue optimization module may determine whether a further markdown step should be pursued. The calculation of 5000 units minus 2000 units results in 3000 remaining units for a second markdown step. At decision 460, the revenue optimization module may determine whether to terminate processing the current potential markdown plan. For example, if the quantity of remaining units is lower than the waste permitted by the business constraints, or if the maximum quantity of markdown steps has been reached, the revenue optimization module may terminate processing the current potential markdown plan. Otherwise, if the revenue optimization module determines that the current potential markdown plan may be continued, the process may return to the beginning (inventory 410). However, for the second markdown step in this plan, the remaining inventory is 3000 units. The various permutations of durations, markdown percentages may be calculated based on a starting inventory of 3000 units.

The benefit of DP may be seen by continuing the above example. If the markdown planning system stores the calculations for each of the permutations for 3000 units, those values may be reused when processing a second potential markdown plan. The second potential markdown plan begins with 5000 units (the starting inventory). However, the first markdown step for the second potential markdown plan uses a 3 week duration with 20% price reduction. The sales volume forecasting module may determine that 2000 units would be sold in the first markdown step. Thus, 3000 units remain. This time, when the revenue optimization module determines the permutations for the second markdown step in the second potential markdown plan, the previously stored values (calculated for the first potential markdown plan) may be reused.

Thus, each markdown step combination represents a subproblem that may be calculated, stored, and later utilized for many potential markdown plans considered by the markdown planning system.

FIG. 5 depicts example calculations that may be performed by a markdown planning system. In FIG. 5, the first example calculation 510 for the estimated sales volume for a markdown step includes a baseline volume 520 multiplied by the formula for determining the effect of a price change/discount 530 multiplied by the effect of seasonality 570 to obtain a weekly sales volume, which is added up for all weeks that are part of the markdown step duration 575 to obtain the estimate. Each of these components are described briefly below.

In some implementations, each retail location may have a baseline price at which a product is to be sold in the long term. The baseline price may be arrived at based on market demand for the item and item cost, and the baseline price may be the highest price that the retail location uses for the item. The baseline price may be referred to as Full unit price (F.U.P.) of an item. A baseline volume is the average de-seasonalized volume sold per time period (such as week) for that product at a retail location, during the non-markdown period when the item is priced at F.U.P. An example formula for baseline volume is shown below:

$${V}_{item , store} = \frac{1}{n} {\sum }_{i = 1}^{n} \frac{{V}_{F . U . P . ( item , store )}}{( Seasonality Index ) week}$$

Where:
F.U.P. is the Full Unit Price (normal retail price) of the item,
V_{F.U.P(item,store)} is the volume sold at Full Unit Price during a week,
Seasonality Index is based on 5 years data, and
n is the number of weeks when F.U.P was active.

To calculate the effect of the price change, the price elasticity 540 is multiplied by the discount amount 550 and divided by the full price 560. This result is added to 1. The formula for the effect of the price change (discount) 530 is shown below:

$$( 1 + \frac{{ϵ}_{item , region} * ( F . U . P {.}_{item , store} - {Price}_{week , item , store} )}{F . U . P {.}_{item , store}} )$$

The ϵ_{item,region} represents a price elasticity. The price elasticity may be a numeric average of point elasticity values calculated during all instances of price change for an item at multiple stores in a region. Below is an example formula for price elasticity:

$${ϵ}_{( item , region )} = \frac{1}{n} {\sum }_{i = 1}^{n} {ϵ}_{i}$$

Where each ϵᵢ is a point elasticity given by

$$ϵ = - \frac{Δ V}{V} \frac{P}{Δ P} ,$$

such that
V is the total volume sold in week k,
P is the price during week k,
ΔP is the price difference between week k+1 and week k, and
ΔV is the volume difference between week k+1 and week k.

The effect of seasonality will vary from week to week. Therefore, for each week during the markdown step duration, the estimated volume calculation would differ. The estimated sales volume for a markdown step may be represented by the formula below:

$${V}_{item , store , week} = {V}_{item , store} * ( 1 + \frac{{ϵ}_{item , region} * ( F . U . P {.}_{item , store} - {Price}_{week , item , store} )}{F . U . P {.}_{item , store}} ) * {( Seasonality Index )}_{week , item , store}$$

The markdown step duration 575 (which may be represented by the variable d) is the amount of time that the markdown step will last. For example, the unit of time (such as weeks or days) may be the same unit of time used for the baseline volume 520. The first example calculation 510 would be the total volume for the duration of the markdown step:

$${V}_{item , store , markdownstep} = {\sum }_{i = 1}^{d} {V}_{item , store , {week}_{i}}$$

A second example calculation 580 shows the aggregate revenue is the sum of revenue per markdown steps (discounted price times volume for all the markdown steps) 590. The volume may be forecast for every week (or another unit of duration) starting from the markdown start week. The prices for each week may be varied according to the constraints mentioned above. Assuming the total number of weeks during the markdown period to be W, for any week wᵢ (<=W), the cumulative sales till that week would be

$${Vtotal}_{w ( i )} = {\sum }_{i = 1}^{w ( i )} {V}_{i}$$

and the cumulative revenue would be

$${Rtotal}_{w ( i )} = {\sum }_{i = 1}^{w ( i )} {V}_{i} * {Price}_{i}$$

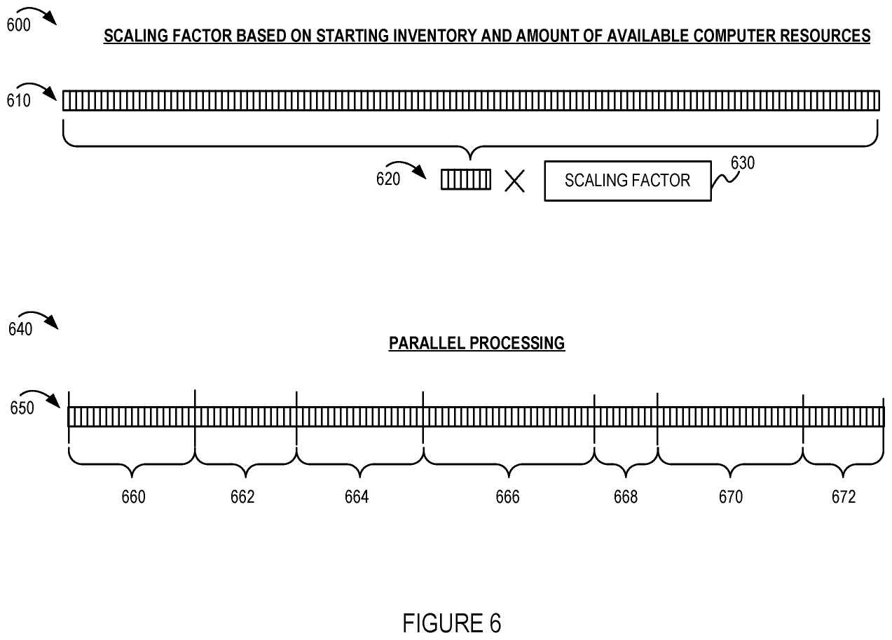

FIG. 6 depicts example variations for a markdown planning system. In a first variation 600, a scaling factor 630 may be used to scale down a full inventory quantity 610 to a scaled inventory value 620. For example, if the full inventory quantity 610 represents 10,000 units, the scaling factor 630 of “5” may result in a scaled inventory value 620 of 2,000 units (10,000/5). As described previously, the markdown planning system may use the scaled inventory value for calculations to simplify and speed up the markdown optimization algorithm. The results may be descaled back to actual inventory quantity before presenting the optimized markdown plan.

A second variation 640 shows parallel processing. The inventory may be segmented. For example, if there are different products within a department catalog, each product may be treated as a separate segment. Another way of segmenting products may be by retail location (store), region, or the like. The segments 660, 662, 664, 666, 668, 670, 672 may be handled by different processes in the same markdown planning system, by different processor units in the markdown planning system, or even by different processing computers. For example, each processing computer may include a corresponding revenue optimization module, sales volume forecasting module, and markdown plan generation module. A plurality of processing computers may form a computer cluster for concurrently determining optimized markdown plans for each of a plurality of products.

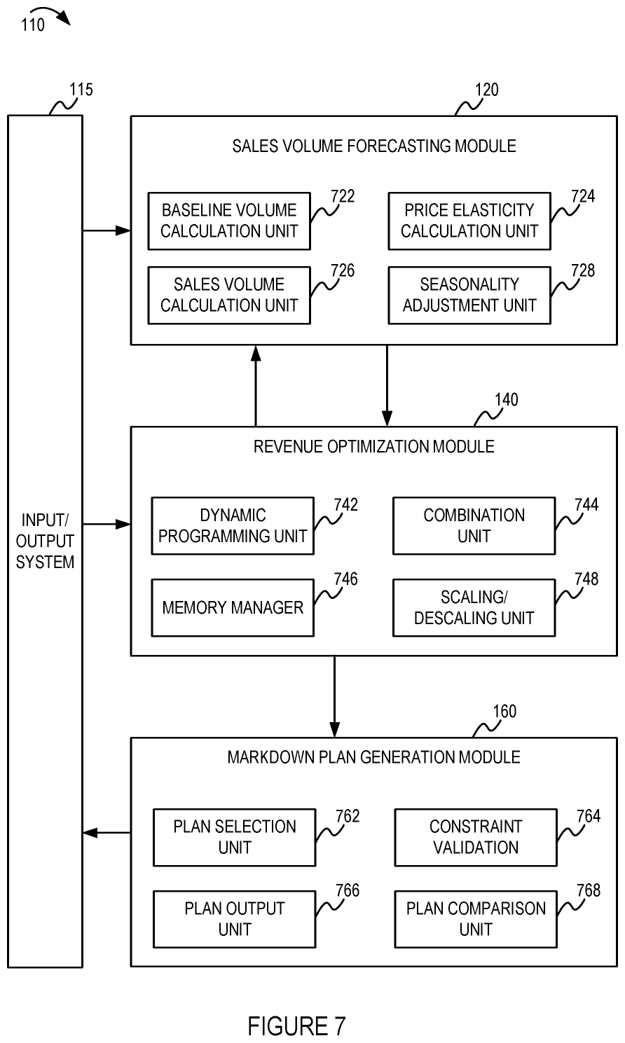

FIG. 7 depicts an example system diagram showing example components of a markdown planning system. The markdown planning system 110 is similar to the one described in FIG. 1, with additional detail to describe example components in the sales volume forecasting module 120, the revenue optimization module 140, and the markdown plan generation module 160. For example, the sales volume forecasting module 120 may include a baseline volume calculation unit 722, a price elasticity calculation unit 724, and a seasonality adjustment unit 728. These blocks may implement formulas similar to those described in FIG. 5. The sales volume forecasting module 120 also may include a sales volume calculation unit 726 that combines (multiplies) the values of the baseline volume calculation unit 722, the price elasticity calculation unit 724, and the sales volume calculation unit 726 to determine an estimated sales volume for a markdown step.

The revenue optimization module 140 may include a memory manager 746 for storing values of previously calculated permutations (markdown step combination). A scaling/descaling unit 748 may determine a scaling factor to reduce the actual starting inventory to a scaled inventory value. The scaling factor may be based on an amount of available computer resource (such as the memory managed by the memory manager 746). A combination unit 744 may determine the various combinations of markdown price, duration, and inventory that would make up a markdown step combination. A dynamic programming unit 742 may refer to the memory to retrieve a previously stored calculation for a markdown step combination, if available.

The markdown plan generation module 160 may include a plan comparison unit 768 and a plan selection unit 762 to select an optimized markdown plan from the potential markdown plans. A constraint validation unit 764 may determine if the selected markdown plan satisfies the set of markdown plan constraints used by the revenue optimization module 140. A plan output unit 766 may provide the optimized markdown plan (via the input/output system 115) to a user interface or to another machine connected by a network.

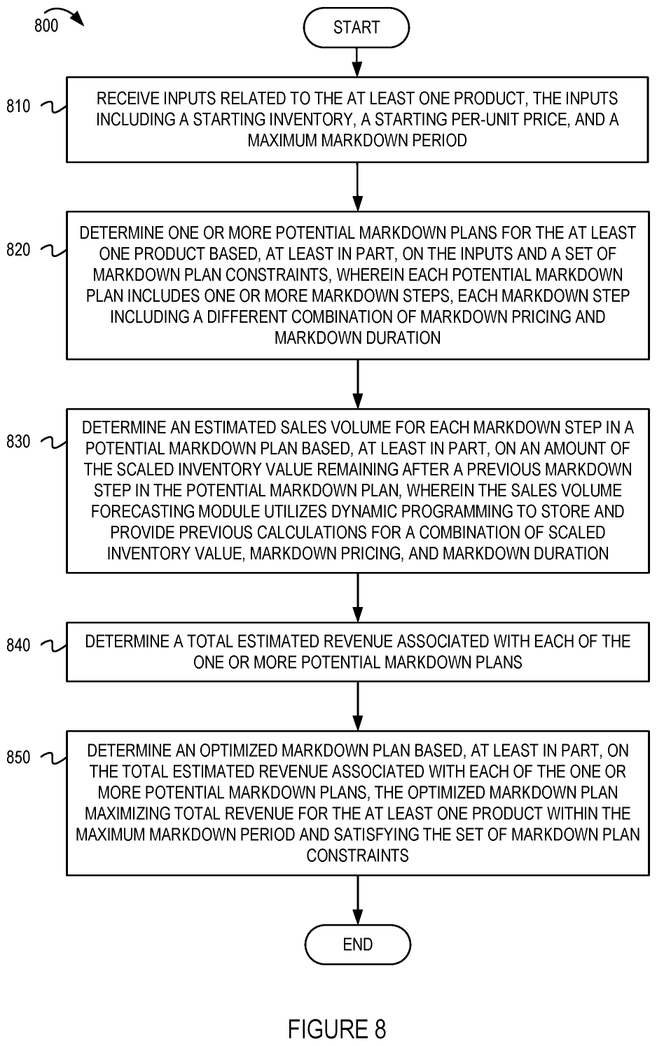

FIG. 8 depicts an example flowchart for determining an optimized markdown plan. The flowchart 800 begins at block 810. At block 810, the markdown planning system may receive inputs related to at least one product. The inputs may include a starting inventory, a starting per-unit price, and a maximum markdown period. The inputs may be received via an input/output system (such as a user interface or a communications interface).

At block 820, the markdown planning system may determine one or more potential markdown plans for the at least one product based, at least in part, on the inputs and a set of markdown plan constraints. Each potential markdown plan may include one or more markdown steps and each markdown step including a different combination of markdown pricing and markdown duration.

At block 830, the markdown planning system may determine an estimated sales volume for each markdown step in a potential markdown plan based, at least in part, on an amount of inventory remaining after a previous markdown step in the potential markdown plan. The markdown planning system may utilize dynamic programming to store and provide previous calculations for a combination of scaled inventory value, markdown pricing, and markdown duration. In some implementations, the markdown planning system may scale the inventory using a scaling factor to make the calculations more manageable or to handle large amounts of inventory. For example, the markdown planning system may determine an amount of an available computing resource in the markdown planning system. The markdown planning system may determine a scaling factor based on the starting inventory and the amount of the available computing resource in the markdown planning system. The markdown planning system may scale the starting inventory to a scaled inventory value based, at least in part, on the scaling factor.

At block 840, the markdown planning system may determine a total estimated revenue associated with each of the one or more potential markdown plans. At block 850, the markdown planning system may determine an optimized markdown plan based, at least in part, on the total estimated revenue associated with each of the one or more potential markdown plans. The optimized markdown plan may maximize total revenue for the at least one product within the maximum markdown period, while still satisfying the set of markdown plan constraints.

### Additional Example Scenarios

Aspects of the disclosure enable various additional scenarios. For example, the markdown planning system may be used to set prices for a product in advance of an expected markdown period. The markdown planning system may be modified to work on any large-scale data optimization problem involving inventory or pricing. The aspects of this disclosure are not limited to retail uses, but also may be used for wholesale, business-to-business, or any other types of commercial transactions involving supply and demand-based pricing.

### Example Operating Environment

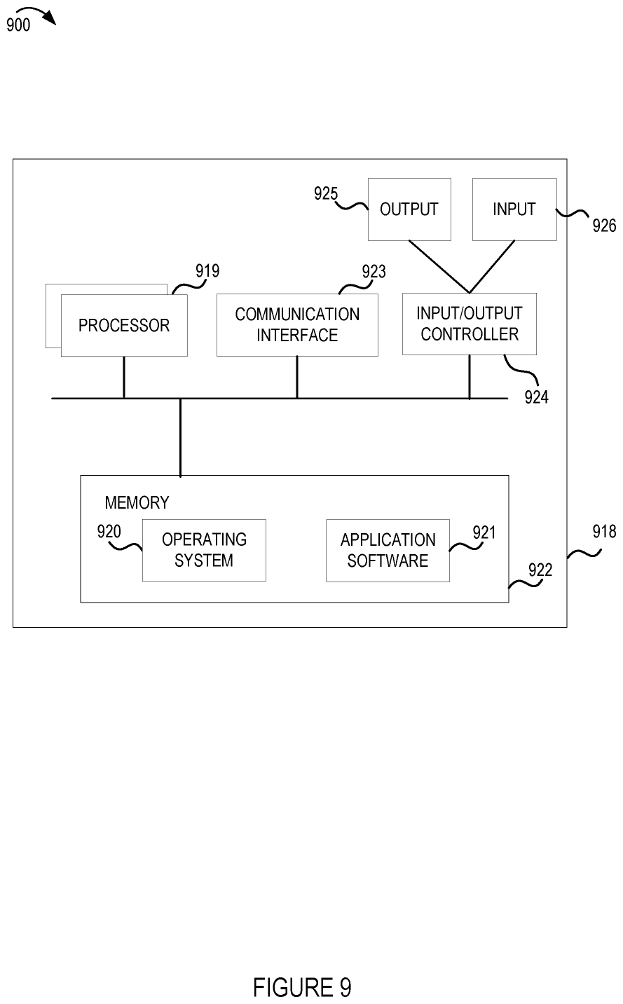

FIG. 9 depicts an example functional block diagram of an operating environment in which some aspects of this disclosure may be implemented. A computing apparatus 918 is depicted according to an embodiment as a functional block diagram. In an embodiment, components of a computing apparatus 918 may be implemented as a part of an electronic device according to one or more embodiments described in this specification. The computing apparatus 918 comprises one or more processors 919 which may be microprocessors, controllers or any other suitable type of processors for processing computer executable instructions to control the operation of the electronic device. Platform software comprising an operating system 920 or any other suitable platform software may be provided on the apparatus 918 to enable application software 921 to be executed on the device. According to an embodiment, identifying a product, obtaining value per weight data and weight data associated with the product, and generating a digital product label including product ID data and product value data of the product as described herein may be accomplished by software.

Computer executable instructions may be provided using any computer-readable media that are accessible by the computing apparatus 918. Computer-readable media may include, for example, computer storage media such as a memory 922 and communications media. Computer storage media, such as a memory 922, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 922) is shown within the computing apparatus 918, it will be appreciated by a person skilled in the art, that the storage may be distributed or located remotely and accessed via a network or other communication link (e.g., using a communication interface 923).

The computing apparatus 918 may comprise an input/output controller 924 configured to output information to one or more output devices 925, for example, a display or a speaker, which may be separate from or integral to the electronic device. The input/output controller 924 may also be configured to receive and process an input from one or more input devices 926, for example, a keyboard, a microphone or a touchpad. In one embodiment, the output device 925 may also act as the input device. An example of such a device may be a touch-sensitive display. The input/output controller 924 may also output data to devices other than the output device, e.g., a locally connected printing device. In some embodiments, a user may provide input to the input device(s) 926 and/or receive output from the output device(s) 925.

The functionality described herein may be performed, at least in part, by one or more hardware logic components. According to an embodiment, the computing apparatus 918 is configured by the program code when executed by the processor 919 to execute the embodiments of the operations and functionality described. Alternatively, or in addition, the functionality described herein may be performed, at least in part, by one or more hardware logic components. For example, and without limitation, illustrative types of hardware logic components that may be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, an application program, computing device, etc.) not shown in the figures.

Although described in connection with an exemplary computing system environment, examples of the disclosure are capable of implementation with numerous other general purpose or special purpose computing system environments, configurations, or devices.

Examples of computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it may execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Alternative Combinations

While the aspects of the disclosure have been described in terms of various examples with their associated operations, a person skilled in the art would appreciate that a combination of operations from any number of different examples is also within the scope of the aspects of the disclosure. Alternatively, or in addition to the other examples described herein, examples include any combination of the following:
an input/output system configured to receive inputs related to the at least one product, the inputs including a starting inventory, a starting per-unit price, and a maximum markdown period;
a revenue optimization module configured to determine an amount of an available computing resource in the markdown planning system;
the revenue optimization module configured to determine a scaling factor based on the starting inventory and the amount of the available computing resource in the markdown planning system;
the revenue optimization module configured to scale the starting inventory to a scaled inventory value based, at least in part, on the scaling factor;
the revenue optimization module configured to determine one or more potential markdown plans for the at least one product based, at least in part, on the inputs and a set of markdown plan constraints, wherein each potential markdown plan includes one or more markdown steps, each markdown step including a different combination of markdown pricing and markdown duration;
a sales volume forecasting module configured to determine an estimated sales volume for each markdown step in a potential markdown plan based, at least in part, on an amount of the scaled inventory value remaining after a previous markdown step in the potential markdown plan, wherein the sales volume forecasting module utilizes dynamic programming to store and provide previous calculations for different combinations of scaled inventory value, markdown pricing, and markdown duration;
a markdown plan generation module configured to determine a total estimated revenue associated with each of the one or more potential markdown plans;
the markdown plan generation module determine an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints;
wherein the sales volume forecasting module is configured to receive a combination of scaled inventory value, markdown pricing, and markdown duration for a markdown step from the revenue optimization module;
wherein the sales volume forecasting module is configured to determine whether the estimated sales volume for the combination is stored in a memory;
if the estimated sales volume is not stored in the memory, the sales volume forecasting module is configured to calculate the estimated sales volume for the combination, provide the estimated sales volume for the markdown step to the revenue optimization module, and store the estimated sales volume for the combination in the memory;
if the estimated sales volume is stored in the memory, the sales volume forecasting module is configured to retrieve the estimated sales volume from the memory, and provide the estimated sales volume for the markdown step to the revenue optimization module;
wherein the sales volume forecasting module is configured to determine the estimated sales volume based, at least in part, on historical sales data, a baseline volume for the product, a sales price, and price elasticity;
wherein the sales volume forecasting module is configured to determine the estimated sales volume based, at least in part, on an effect of seasonality associated with the at least one product;
wherein the available computing resource is memory, and the amount of the available computing resource is limited based, at least in part, on a system architecture of the markdown planning system;
wherein the set of the markdown plan constraints include at least one constraint selected from a group consisting of a maximum quantity of markdown steps, a minimum duration between markdown steps, a maximum waste amount, a sell-through target, and minimum markdown percentage for each step;
wherein the revenue optimization module is further configured to discard a potential markdown plan that does not satisfy the set of the markdown plan constraints;
wherein the markdown plan generation module is further configured to verify that the optimized markdown plan satisfies the set of markdown plan constraints;
wherein the set of markdown plan constraints are user-configurable parameters or system-configurable parameters;
wherein the input/output system includes a user interface;
wherein the markdown plan generation module is further configured to provide the optimized markdown plan via the user interface;
wherein the input/output system is configured to receive different inputs for each of a plurality of products;
wherein the markdown planning system uses parallel processing to determine a corresponding optimized markdown plan for each of the plurality of products;
a plurality of processing computers, wherein each processing computer includes a corresponding revenue optimization module, sales volume forecasting module, and markdown plan generation module;
wherein the plurality of processing computers forms a computer cluster for concurrently determining optimized markdown plans for each of a plurality of products;
receiving, via an input/output system of the markdown planning system, inputs related to the at least one product, the inputs including a starting inventory, a starting per-unit price, and a maximum markdown period;
determining an amount of an available computing resource in the markdown planning system;
determining a scaling factor based on the starting inventory and the amount of the available computing resource in the markdown planning system;
scaling the starting inventory to a scaled inventory value based, at least in part, on the scaling factor;
determining one or more potential markdown plans for the at least one product based, at least in part, on the inputs and a set of markdown plan constraints, wherein each potential markdown plan includes one or more markdown steps, each markdown step including a different combination of markdown pricing and markdown duration;
determining, by a sales volume forecasting module of the markdown planning system, an estimated sales volume for each markdown step in a potential markdown plan based, at least in part, on an amount of the scaled inventory value remaining after a previous markdown step in the potential markdown plan, wherein the sales volume forecasting module utilizes dynamic programming to store and provide previous calculations for a combination of scaled inventory value, markdown pricing, and markdown duration;
determining, by a revenue optimization module of the markdown planning system, a total estimated revenue associated with each of the one or more potential markdown plans;
determining, by the revenue optimization module, an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints;
means for receiving inputs related to the at least one product, the inputs including a starting inventory, a starting per-unit price, and a maximum markdown period;
determining an amount of an available computing resource in the markdown planning system;
means for determining a scaling factor based on the starting inventory and the amount of the available computing resource in the markdown planning system;
means for scaling the starting inventory to a scaled inventory value based, at least in part, on the scaling factor;
means for determining one or more potential markdown plans for the at least one product based, at least in part, on the inputs and a set of markdown plan constraints, wherein each potential markdown plan includes one or more markdown steps, each markdown step including a different combination of markdown pricing and markdown duration;
means for determining an estimated sales volume for each markdown step in a potential markdown plan based, at least in part, on an amount of the scaled inventory value remaining after a previous markdown step in the potential markdown plan;
wherein the sales volume forecasting module utilizes dynamic programming to store and provide previous calculations for a combination of scaled inventory value, markdown pricing, and markdown duration;
means for determining a total estimated revenue associated with each of the one or more potential markdown plans; and
means for determining, by the revenue optimization module, an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

The phrase “based on” is used in this specification to represent influenced by, including, or derived from the feature(s) or act(s) followed thereafter. The phrase “based on” may be synonymous to the phrase “based, at least in part, on.”

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A markdown planning system, comprising:
an input/output system configured to receive inputs related to the at least one product, the inputs including a starting inventory, a starting per-unit price, and a maximum markdown period;
a revenue optimization module configured to:
determine an amount of an available computing resource in the markdown planning system,
determine a scaling factor based on the starting inventory and the amount of the available computing resource in the markdown planning system,
scale the starting inventory to a scaled inventory value based, at least in part, on the scaling factor, and
determine one or more potential markdown plans for the at least one product based, at least in part, on the inputs and a set of markdown plan constraints, wherein each potential markdown plan includes one or more markdown steps, each markdown step including a different combination of markdown pricing and markdown duration;
a sales volume forecasting module configured to:
determine an estimated sales volume for each markdown step in a potential markdown plan based, at least in part, on an amount of the scaled inventory value remaining after a previous markdown step in the potential markdown plan, wherein the sales volume forecasting module utilizes dynamic programming to store and provide previous calculations for different combinations of scaled inventory value, markdown pricing, and markdown duration; and
a markdown plan generation module configured to:
determine a total estimated revenue associated with each of the one or more potential markdown plans, and
determine an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints.

2. The markdown planning system of claim 1, wherein the sales volume forecasting module is configured to:
receive a combination of scaled inventory value, markdown pricing, and markdown duration for a markdown step from the revenue optimization module,
determine whether the estimated sales volume for the combination is stored in a memory,
if the estimated sales volume is not stored in the memory:
calculate the estimated sales volume for the combination,
provide the estimated sales volume for the markdown step to the revenue optimization module, and
store the estimated sales volume for the combination in the memory,
if the estimated sales volume is stored in the memory:
retrieve the estimated sales volume from the memory, and
provide the estimated sales volume for the markdown step to the revenue optimization module.

3. The markdown planning system of claim 1, wherein the sales volume forecasting module is configured to determine the estimated sales volume based, at least in part, on historical sales data, a baseline volume for the product, a sales price, and price elasticity.

4. The markdown planning system of claim 1, wherein the sales volume forecasting module is configured to determine the estimated sales volume based, at least in part, on an effect of seasonality associated with the at least one product.

5. The markdown planning system of claim 1, wherein the available computing resource is memory, and the amount of the available computing resource is limited based, at least in part, on a system architecture of the markdown planning system.

6. The markdown planning system of claim 1, wherein the set of the markdown plan constraints include at least one constraint selected from a group consisting of a maximum quantity of markdown steps, a minimum duration between markdown steps, a maximum waste amount, a sell-through target, and minimum markdown percentage for each step.

7. The markdown planning system of claim 1, wherein the revenue optimization module is further configured to discard a potential markdown plan that does not satisfy the set of the markdown plan constraints.

8. The markdown planning system of claim 1, wherein the markdown plan generation module is further configured to verify that the optimized markdown plan satisfies the set of markdown plan constraints.

9. The markdown planning system of claim 1, wherein the set of markdown plan constraints are user-configurable parameters or system-configurable parameters.

10. The markdown planning system of claim 1,
wherein the input/output system includes a user interface, and
wherein the markdown plan generation module is further configured to provide the optimized markdown plan via the user interface.

11. The markdown planning system of claim 1,
wherein the input/output system is configured to receive different inputs for each of a plurality of products, and
wherein the markdown planning system uses parallel processing to determine a corresponding optimized markdown plan for each of the plurality of products.

12. The markdown planning system of claim 1, further comprising:
a plurality of processing computers, wherein each processing computer includes a corresponding revenue optimization module, sales volume forecasting module, and markdown plan generation module, and
wherein the plurality of processing computers forms a computer cluster for concurrently determining optimized markdown plans for each of a plurality of products.

13. A method performed by a markdown planning system, comprising:
receiving, via an input/output system of the markdown planning system, inputs related to the at least one product, the inputs including a starting inventory, a starting per-unit price, and a maximum markdown period;
determining an amount of an available computing resource in the markdown planning system;
determining a scaling factor based on the starting inventory and the amount of the available computing resource in the markdown planning system;
scaling the starting inventory to a scaled inventory value based, at least in part, on the scaling factor;
determining one or more potential markdown plans for the at least one product based, at least in part, on the inputs and a set of markdown plan constraints, wherein each potential markdown plan includes one or more markdown steps, each markdown step including a different combination of markdown pricing and markdown duration;
determining, by a sales volume forecasting module of the markdown planning system, an estimated sales volume for each markdown step in a potential markdown plan based, at least in part, on an amount of the scaled inventory value remaining after a previous markdown step in the potential markdown plan, wherein the sales volume forecasting module utilizes dynamic programming to store and provide previous calculations for a combination of scaled inventory value, markdown pricing, and markdown duration;
determining, by a revenue optimization module of the markdown planning system, a total estimated revenue associated with each of the one or more potential markdown plans; and
determining, by the revenue optimization module, an optimized markdown plan based, at least in part, on the total estimated revenue associated with each of the one or more potential markdown plans, the optimized markdown plan maximizing total revenue for the at least one product within the maximum markdown period and satisfying the set of markdown plan constraints.

14. The method of claim 13, further comprising:
receiving, by the sales volume forecasting module, a combination of scaled inventory value, markdown pricing, and markdown duration for a markdown step from the revenue optimization module,
determining whether the estimated sales volume for the combination is stored in a memory,
if the estimated sales volume is not stored in the memory:
calculating the estimated sales volume for the combination,
providing the estimated sales volume for the markdown step to the revenue optimization module, and
storing the estimated sales volume for the combination in the memory,
if the estimated sales volume is stored in the memory:
retrieving the estimated sales volume from the memory, and
providing the estimated sales volume for the markdown step to the revenue optimization module.

15. The method of claim 13, wherein the estimated sales volume is based, at least in part, on historical sales data, a baseline volume for the product, a sales price, and price elasticity.

16. The method of claim 13 wherein the estimated sales volume is based, at least in part, on an effect of seasonality associated with the at least one product.

17. The method of claim 13, wherein the set of the markdown plan constraints include at least one constraint selected from a group consisting of a maximum quantity of markdown steps, a minimum duration between markdown steps, a maximum waste amount, a sell-through target, and minimum markdown percentage for each step.

18. The method of claim 13, further comprising:
verifying that the optimized markdown plan satisfies the set of markdown plan constraints.

19. The method of claim 13, wherein the set of markdown plan constraints are user-configurable parameters or system-configurable parameters.

20. The method of claim 13, wherein the input/output system includes a user interface, the method further comprising:
providing the optimized markdown plan via the user interface.
